(19) United States
(12) Patent Application Publication
(10) Pub. No.: US 2019/0203124 A1
(43) Pub. Date: Jul. 4, 2019

(54) APPARATUS AND METHOD FOR CLEANING A VESSEL

(71) Applicant: ExxonMobil Research and Engineering Company, Annandale, NJ (US)

(72) Inventor: Hugh A. Roth, Edmonton (CA)

(21) Appl. No.: 16/217,137

(22) Filed: Dec. 12, 2018

Related U.S. Application Data
(60) Provisional application No. 62/611,096, filed on Dec. 28, 2017.

(51) Int. Cl. C10B 43/08; B08B 9/093

(52) U.S. Cl. CPC C10B 43/08; B08B 9/093

(57) ABSTRACT

Described is an apparatus and method for cleaning a coker cyclone vessel utilizing shape-memory alloy. The apparatus may include a rigid conduit insertable through the coker cyclone and a continuous tubing made of shape-memory alloy insertable and movable into and through the rigid conduit to allow extension through the length of the coker cyclone to apply high pressurized liquid cleaning.

### CROSS-REFERENCE TO RELATED APPLICATIONS

This application claims priority to U.S. Provisional Application Ser. No. 62/611,096 filed Dec. 28, 2017, which is herein incorporated by reference in its entirety.

### FIELD OF THE INVENTION

This invention relates to apparatus and methods for cleaning a vessel such as one or more cyclones as part of a coker.

### BACKGROUND OF THE INVENTION

Many types of vessels pose cleaning difficulties. One type of vessel in which particularly disadvantageous cleaning difficulties arise is a coker such as certain (e.g. dense phase) cyclone reactor cokers. Such cokers typically have a plurality of “snouts” (usually 1-7 snouts) disposed circumferentially around the inside of an upper (e.g. scrubber) region of the coker. Each snout may include an elbow joint and is typically in communication with a respective gas tube extending vertically downward within the cyclone. Below the gas tube is a void area creating a cyclone effect, and a dip leg extending beneath the void area. Cokers of this type are typically on the order of 100 meters (several hundred feet) tall, and a typical distance from the top of the snout to the bottom of the dip leg may be about 85 feet (26 meters), for example.

Such cyclones typically operate at high internal temperatures (e.g. in excess of 450° C.) and elevated internal vapor velocities. Cokers of this type are typically designed to operate continuously. Over time, coke deposits tend to build up within various internal components of the coker, such as the snouts, gas tubes and dip legs, gradually decreasing the efficiency of the vapor-solid separation process. As this starts to reduce process efficiency, the coker may need to be shut down for manual internal cleaning. Due to the internal operating conditions of the coker, such coke deposits are typically as hard as concrete, and are difficult to clean. Accordingly, it is not uncommon for cyclone reactor cokers to be subject to a lengthy cleaning process, resulting in high clean-up costs and lost revenues.

U.S. Pat. No. 8,377,231 discloses an apparatus for cleaning a vessel that includes a continuous tubing made of standard carbon oilfield steel tubing insertable through an elongated rigid conduit into the vessel, for conducting pressurized liquid into the vessel to clean the vessel. However, one concern regarding these types of constructions is that the continuous tubing used sometimes does not reach to the full extent of the cyclone.

One cause of limited cleaning could be the continuous tubing bending and buckling at the gas outlet tube elbow. The continuous tubing bending and buckling at the gas outlet tube elbow can be attributed to elastic instability of the standard carbon material, combined with high injection pressure and peak loading force applied to the continuous tubing during cleaning.

There is a need for an improved method and apparatus for cleaning a coker cyclone vessel.

### SUMMARY OF THE INVENTION

Disclosed is an apparatus for cleaning a vessel comprising: a) a vessel having plurality of cyclones, each cyclone having a cyclone snout, a gas outlet tube, a dip leg and a length measured from the cyclone snout to the dip leg; b) a rigid conduit insertable through the cyclone snout making a fluid connection with the gas outlet tube; c) a continuous tubing insertable and movable into and through the rigid conduit of sufficient length to allow extension through the length of the cyclone; d) wherein the continuous tubing inserted into the cyclone makes an angle of less than 180° at the gas outlet tube; and e) wherein the continuous tubing comprises (or consists essentially, or consists) of shape-memory alloy, such as one in a superelastic condition.

Also disclosed is a method for cleaning a vessel, comprising: a) providing a continuous tubing, such as one comprising (or consisting essentially, or consisting) of a shape-memory alloy preferably in a superelastic condition, having a nozzle and connectable to a liquid supplying device for conducting pressurized liquid; b) providing a vessel having a cyclone snout connected to an internal dip leg through a gas outlet tube, the snout having a centerline; c) angling the nozzle of the continuous tubing so that the tip of the nozzle is aligned with the snout centerline; d) inserting the continuous tubing (for example, with a peak loading force of between 1000 lbf to 5000 lbf) through the vessel snout into the gas outlet tube making an angle of less than 180° and capable of reaching the dip leg; and e) applying water spray to the vessel through the continuous tubing.

### BRIEF DESCRIPTION OF THE FIGURES

FIG. 1 is a perspective view of apparatus for cleaning a vessel, according to any embodiment of the invention;

FIG. 2 is a top view of the apparatus shown in FIG. 1;

FIG. 3 is a side view of the apparatus shown in FIG. 1;

FIGS. 4-5 show a coker vessel to be cleaned by the apparatus shown in FIG. 1; and

FIG. 6 shows a continuous tubing of the apparatus shown in FIG. 1, inserted into the coker vessel shown in FIGS. 4 and 5.

### DETAILED DESCRIPTION

The inventor has found that continuous tubing comprising (or consisting essentially of or consisting of) of a shape-memory alloy such as those in a superelastic condition, such as nickel titanium alloy, enables further reach of the continuous tubing into a vessel such as the one or more cyclones of a coker vessel. Shape-memory alloy materials are able to experience much greater strain than standard carbon oilfield steel and still return to its original shape. Furthermore, by limiting the peak loading force and injection pressure of the coiled tubing from the cleaning process, this enables the continuous tubing to navigate through the coker cyclone vessel without experiencing buckling.

Provided in any embodiment is an apparatus for cleaning a vessel such as a coker comprising a one or more (or a plurality) of internal settling means such as a cyclone, such settling means having a top opening to allow gases to flow outwards for instance and a bottom opening to allow solid particles to collect and exit for example, wherein a continuous tubing insertable and movable into and through top opening of the settling means of sufficient length to allow extension through the length of the settling means, and preferably the entire vessel. More particularly, a coker cyclone is provided having plurality of cyclones, each having a cyclone snout, a gas outlet tube, a dip leg and a length from the cyclone snout to the dip leg; and providing a rigid conduit insertable through the coker cyclone snout making a fluid connection with the gas outlet tube within the coker cyclone; and further providing a continuous tubing insertable and movable into and through the rigid conduit of sufficient length to allow extension through the length of the coker cyclone, wherein the continuous tubing inserted into the coker cyclone makes an angle of less than 180° (or 100°) at the gas outlet tube, and wherein the continuous tubing consists of shape-memory alloy.

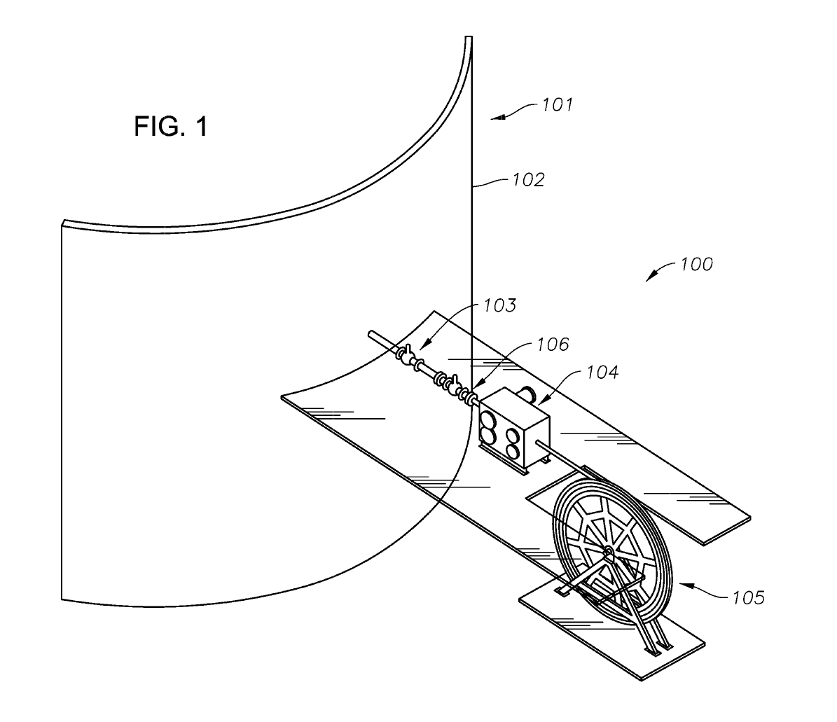

Features of the claimed invention(s) can be described with reference to drawings. Referring to FIG. 1, an apparatus according to any embodiment of the invention is shown generally at 100. In any embodiment the apparatus 100 is used for cleaning a vessel shown generally at 101, which in any embodiment includes a coker reactor cyclone. The apparatus 100 is adapted to clean the vessel 101 while the vessel 101 is “live” (i.e., in operation).

In any embodiment, the apparatus 100 includes an elongated continuous tubing shown generally at 108, insertable through an elongated rigid conduit shown generally at 106 into the vessel 101, for conducting pressurized liquid into the vessel to clean the vessel.

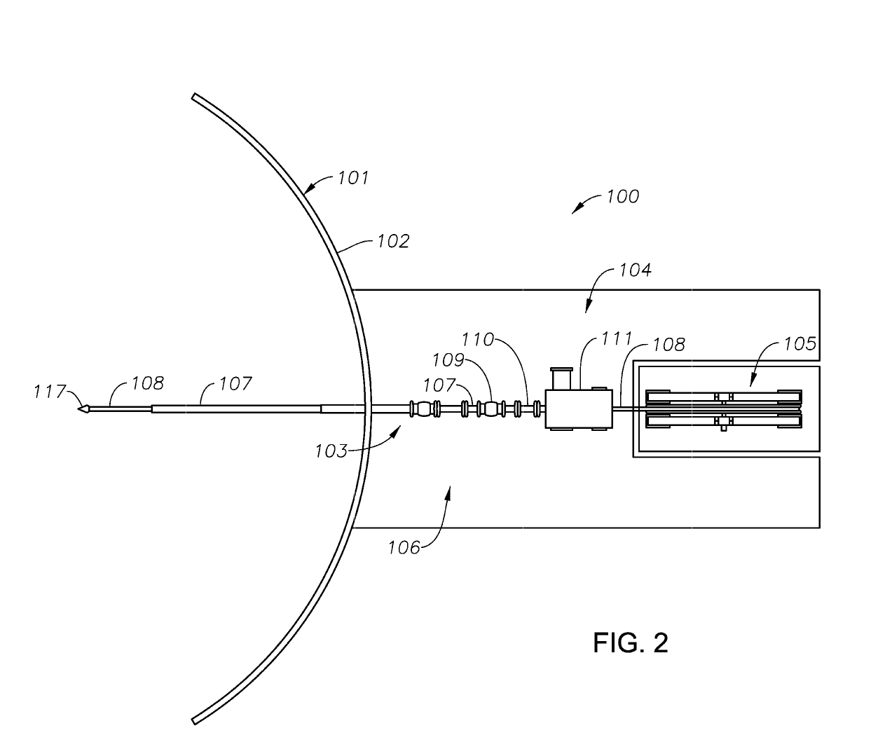

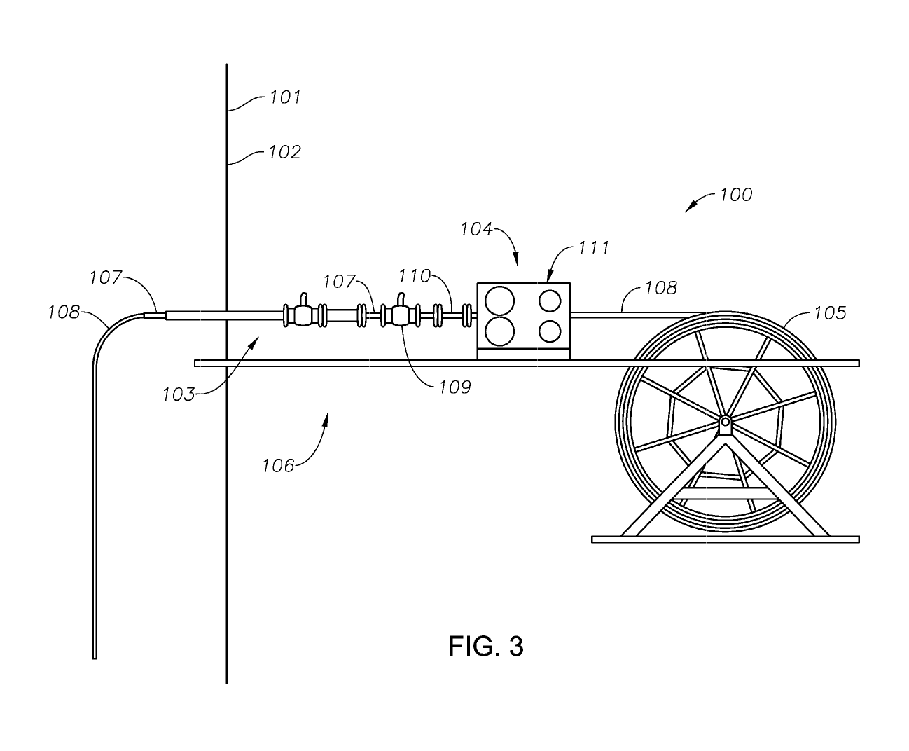

Referring to FIGS. 2 and 3, the apparatus is shown in greater detail at 100. In any embodiment, the continuous tubing 108 comprises of shape-memory alloy such as one in a superelastic condition. As used herein, the term “shape-memory alloy” refers to a material or composition of materials such as metal(s) that after being bent or shaped will obtain its original shape, or the shape in which it was originally formed, and can sustain large strains without plastic deformation. Typical steel can endure a strain of about 0.2% before plastically deforming. As used herein a material in “superelastic” condition can endure strain of greater than 0.2% before plastic deformation. Preferably, the material in superelastic condition can endure greater than 0.5%, or greater than >1%, or greater than 5%, or greater than to 10% strain before plastic deformation. Preferably, the material is treated (e.g. heat treated) to reach its superelastic condition.

Shape memory alloys, such as nickel-titanium, undergo a phase transformation in their crystal structure when cooled from the stronger, high temperature form (austenite) to the weaker, low temperature form (martensite). This inherent phase transformation is the basis for the unique properties of these alloys. When a shape-memory alloy is in its martensitic form, it is easily deformed to a new shape. However, when the alloy is heated through its transformation temperatures, it reverts to austenite and recovers its previous shape with great force. This process is known as “shape memory.” The temperature at which the alloy remembers its high temperature form when heated can be adjusted by slight changes in alloy composition and through heat treatment. For instance, in nickel-titanium alloys it can be changed from above +100° C. to below −100° C. The shape recovery process occurs over a range of just a few degrees and the start or finish of the transformation can be controlled to within a degree or two if necessary. Such shape-memory allows are commonly used in small wiring applications, the present invention(s) contemplate using such shape-memory allows in tubing having an outside diameter of at least 0.5 (1.3), or 1 (2.5), or 1.2 (3.0), or 1.4 (3.6) or 1.6 (4.1), or 1.8 (4.6), or 2 inches (5.1 cm), and wall thickness that may be from 0.5 to 3, or 4 mm.

In any embodiment the shape-memory alloy of the continuous tubing 108 may include nickel titanium alloy or copper aluminum alloy. In any embodiment, the specific composition of the nickel titanium is comprises of nickel within a range from 50 to 70% by weight and titanium within a range from 30 to 50% by weight. More preferably, the nickel titanium alloy consists essentially of 60% nickel and 40% titanium by weight.

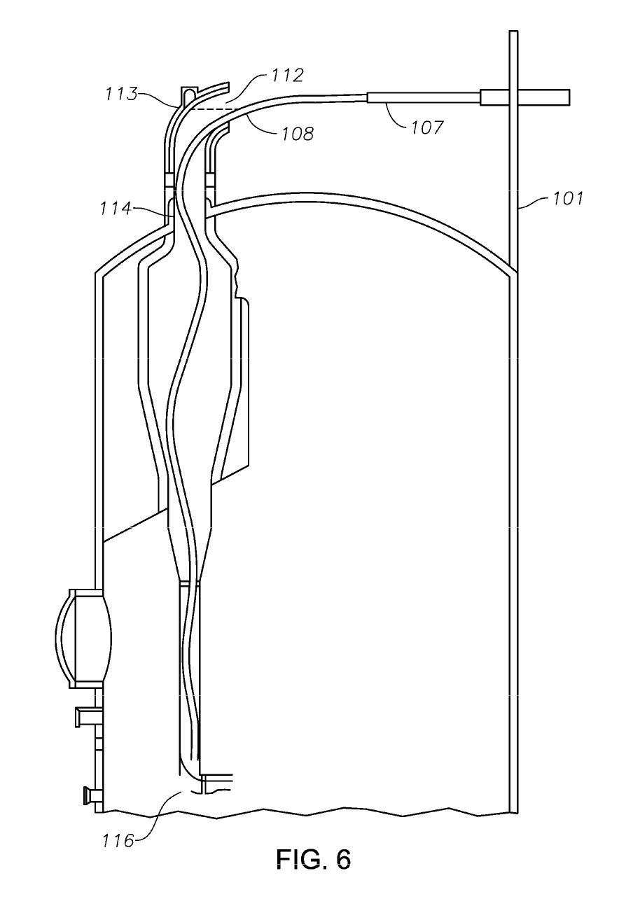

In any embodiment, the continuous tubing 108 is attached with a roller ball attachment to aid in navigation of the continuous tubing 108 inside the gas outlet tube 114 shown in FIG. 6. In any embodiment, the continuous tubing can have an outside diameter (OD) within a range from 0.9, or 1, or 1.1, or 1.2 to 1.25, or 1.3, or 1.4 inches, and can have for example a wall thickness of between 0.07, or 0.08, or 0.085 inches to 0.12, or 0.13, or 0.135 inches.

In any embodiment, the apparatus 100 further includes an insertion device 104 for inserting the continuous tubing 108 through the rigid conduit 106 into the vessel 101. More particularly, in any embodiment, the insertion device 104 includes an injector assembly 111 operable to grip the continuous tubing 108 and push the continuous tubing through the rigid conduit 106. The insertion device 104 is preferably powered by a hydraulic power unit (not shown). In any embodiment, the apparatus 100 further includes the rigid conduit 106.

### Coker Vessel

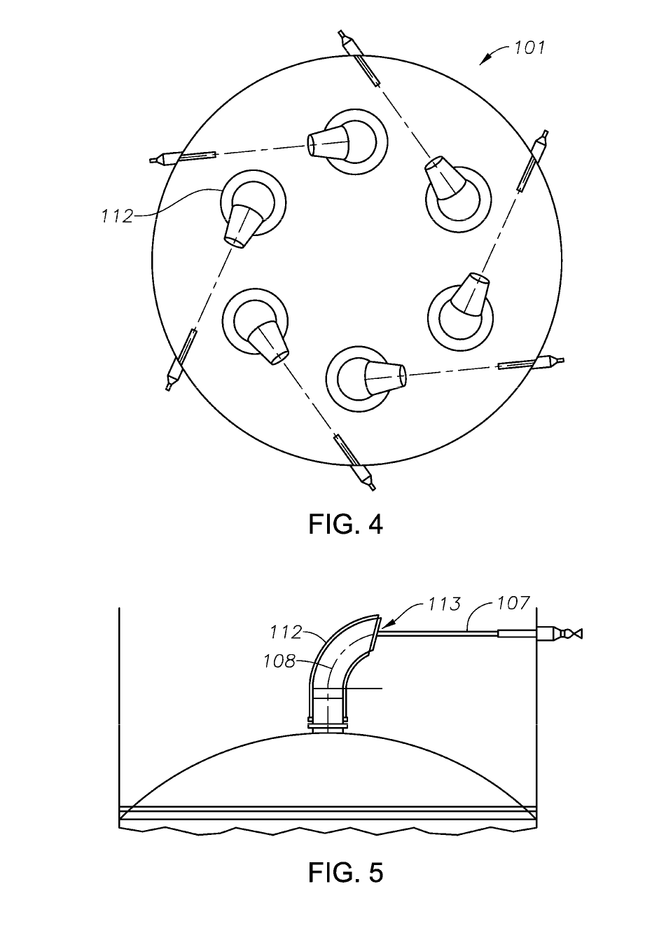

The apparatus described herein can comprise any type of vessel having at least one cyclone, but in a preferred embodiment the vessel is a coker vessel. Referring to FIGS. 4 through 6, the vessel 101, which in any embodiment includes a coker vessel, is shown in greater detail in FIG. 4. In any embodiment, the vessel 101 is a cyclone reactor coker vessel. The coker vessel 101 has a plurality of cyclone snouts shown generally at 112, disposed circumferentially around an upper inside region of the coker vessel. Each cyclone snout, such as that shown at 112 for example, includes an elbow joint that may have a diameter ranging from 10, or 15, or 20 to 26, or 30, or 34 inches, and has an imaginary opening centerline as shown at 115 of FIG. 6, and is in communication with a respective (e.g. 24 inch, or 61 centimeter) gas outlet tube, such as that shown at 114 in FIG. 6 for example, extending vertically downward within the coker vessel. Below each gas tube is a void area for providing a cyclone effect, below which a dip leg extends beneath the void area.

Referring back to FIGS. 1 and 6, In any embodiment, the coker vessel may be on the order of 100 meters (several hundred feet) tall, and the existing valve assembly 103 protrudes from the wall 102 of the vessel 101 at a height such as from ¼ to ¾ from the bottom of the coker, such as 220 feet (67 meters) above the ground, or about 85 feet (26 meters) above a vicinity 116 of the dip leg.

### Operation

Referring to FIGS. 2 through 6, the rigid conduit 106 extends sufficiently far into the vessel 101 to support the continuous tubing 108 to allow the continuous tubing 108 to be inserted into one of the cyclone snouts 112. The continuous tubing 108 having a cleaning nozzle 117 and connectable to a liquid supplying device for conducting pressurized liquid.

The continuous tubing 108 is inserted into the cyclone snouts 112 and makes an angle of less than 180, or 140, or 120, or 100 degrees, or within a range from 40, or 50, or 90 to 100, or 120, or 140, or 180 degrees, at gas outlet tube 114 without buckling. The angle that the nozzle 117 of the continuous tubing enters the mouth 113 of the cyclone snout 112 is preferably aligned parallel with the snout centerline 115, and more preferably the nozzle is angled at least 5, or 6, or 8 inches above the snout centerline 115.

Significant deflection in the continuous tubing due to self-weight and gas impingement may risk having the continuous tubing miss the snout during injection, especially when snout is narrowed with coke fouling. In any embodiment, installing coiled tubing straighteners on the continuous tubing 108, such as those available on C-TECH rigs, could improve the probability of the continuous tubing entering the snout at the desired position.

The injector assembly 111 is attached to a rear of the continuous tubing pack-off 110 such that it makes a fluid connection. The injector assembly 111 employs its hydraulic motor and planetary gear reducer equipped with shear pins to drive the continuous tubing 108 into or out of the vessel as required, and the electronic components of the injector assembly monitor and display the length of continuous tubing 108 presently inserted into the vessel 101, as well as the current rate of travel of the continuous tubing 108 into or out of the vessel 101.

The continuous tubing 108 may be inserted into the vessel 101 by any means, and may be a standalone tube, or shrouded in one or more concentric jackets or shrouds, and/or coupled to another device to assist the insertion into vessel 101. In any embodiment the continuous tubing 108 has an input end connected to the liquid junction 212 at the center of the reel 105, and is coiled around the reel. An output end of the continuous tubing extends off the reel, through the injector assembly 111, through the continuous tubing pack-off 132, the shroud valve 109, and the shroud 107 and extends through the shroud 107 into the vessel 101. The continuous tubing 108 includes a cleaning nozzle 117 at an output end thereof. The continuous tubing transports high pressure water from the liquid junction 212 of the reel 105 to the cleaning nozzle 117 and out there through, to clean the cyclone snout 112 and regions of the vessel 101 further down, in and below the gas outlet tube 114, down to the vicinity 116 of the dip leg.

Thus, in any embodiment, to use the apparatus 100 to clean components of the vessel 101, the continuous tubing 108 is inserted through the elongated rigid conduit into the vessel 101, and pressurized liquid is conducted through the continuous tubing 108 into the vessel 101 to clean the vessel (e.g. cyclone).

More particularly, referring to FIGS. 2 and 5, the rigid shroud 107 extends into the vicinity of a mouth 113 of the cyclone snout 112. The injector assembly 111 forces the continuous tubing 108 through the rigid shroud 107 and through the mouth 113 of the cyclone snout 112. As the nozzle 117 of the continuous tubing 108 enters the mouth 113 of the cyclone snout 112, high pressure pumps are activated to supply water through the liquid junction of the reel 105, through the input end of the continuous tubing 108, and out through the nozzle 117 of the continuous tubing 108, into the cyclone snout 112.

High pressure water is forced through nozzle 117 by any means, such as by the use of high pressure pumps forcing the water through the nozzle 117 at a high pressure. In some embodiments, the maximum pressure can be 300 psi (2 MPa), or 400 psi (3 MPa), or 500 psi (3.5 MPa), 600 psi (4 MPa), 800 psi (5.5 MPa), 1,000 psi (6.9 MPa), 4,000 psi (27.6 MPa), 8,000 psi (55 MPa), and up to 12,000 psi (82.7 MPa). In some embodiments, the water pressure can be within a range from 200 psi (1.5 MPa), or 250 psi (1.75 MPa) to 300 psi (2 MPa), or 350 psi (2.5 MPa), or 400 psi (3 MPa), for cleaning hardened coke from the cyclone snout 112 and other components of the vessel.

Once the nozzle 117 has been inserted into the mouth 113 of the cyclone snout 112 and the high pressure liquid flow has been commenced, the injector assembly 111 slowly injects the continuous tubing further into the vessel 101.

To facilitate the continuous tubing 108 reaching the vicinity of the dip leg 116, a minimum of peak loading force of 1000, or 1600, or 1800, or 2000, or 2200 lbf may be applied to facilitate the continuous tubing to navigate through the gas outlet tube 114.

Greater peak loading force may increase the likelihood that the continuous tubing 108 will buckle or bend at the gas outlet tube 114 preventing the continuous tubing 108 from reaching further down the vessel. A suitable maximum peak load depends on the geometry and properties of the continuous tubing and can be adjusted accordingly. In some embodiments, the peak loading force applied is no greater than 4000, or 4500, or 5000, or 5500 lbf.

The shape of the cyclone snout 112 assists in guiding the nozzle 117 of the continuous tubing 108 in a generally downward direction as the injector assembly continues to inserts additional length of the continuous tubing 108 into the vessel 101. Thus, as the continuous tubing 108 is gradually inserted into the vessel 101, the high pressure water flow from the nozzle 117 gradually cleans the cyclone snout 112 by forcibly removing coke build-up from the inside of the cyclone snout 112. This coke removal cleaning action continues as the nozzle 117 moves further down through the gas outlet tube 114, and coke build-up is thus similarly removed from the gas outlet tube. The injector assembly 111 continues to gradually insert the continuous tubing 108 into the vessel 101, so that the nozzle 117 of the continuous tubing 108 extends progressively further downward through the gas tube, through the cyclone effect void beneath the gas tube, and into the vicinity 116 of the dip leg, to remove coke obstructions in the dip leg. When the display on the injector assembly indicates that a sufficient length of continuous tubing 108 has been inserted into the vessel 101 to place the nozzle 117 in the vicinity of the dig leg, the insertion of the continuous tubing into the vessel 101 by the injector assembly 111 is halted. The injector assembly 111 may be reversed, to begin pulling the continuous tubing 108 back out of the vessel 101.

The apparatus described herein can also be described with respect to the process used for cleaning a coker. For example, in any embodiment is a method for cleaning a coker cyclone, comprising providing a continuous tubing having a nozzle and connectable to a liquid supplying device for conducting pressurized liquid; and also providing a coker cyclone having a cyclone snout connected to an internal dip leg through a gas outlet tube, the snout having a centerline. The process then includes angling the nozzle of the continuous tubing so that the tip of the nozzle is aligned with the snout centerline. Preferably, the continuous tubing is inserted (such as with a peak loading force of between 1000 lbf to 5000 lbf) through the coker cyclone snout into the gas outlet tube making an angle of less than 180° (or 100°) and reaching the dip leg. Finally, a water spray may be applied to the coker cyclone through the continuous tubing.

Thus, for instance, continuous tubing 108 can be inserted into the snout 112 with a sufficient force to navigate through the gas outlet tube 114 without buckling and reaches the dip leg 116 of the coker. As the continuous tubing 108 move downwards into the coker, high pressure water flow from the nozzle 117 gradually cleans the components of the coker. Once cleaning is done, the continuous tubing 108 is retrieved out of the coker vessel 101.

Embodiments of the invention include the following and combinations thereof.

### Embodiment 1

An apparatus for cleaning a vessel comprising: a) a vessel having plurality of cyclones, each cyclone having a cyclone snout, a gas outlet tube, a dip leg and a length measured from the cyclone snout to the dip leg; and b) a rigid conduit insertable through the cyclone snout making a fluid connection with the gas outlet tube; and c) a continuous tubing insertable and movable into and through the rigid conduit of sufficient length to allow extension through the length of the cyclone; d) wherein the continuous tubing inserted into the cyclone makes an angle of less than 180° at the gas outlet tube; and e) wherein the continuous tubing comprises shape-memory alloy in a superelastic condition.

### Embodiment 2

The apparatus of the preceding embodiment, wherein the continuous tubing consists essentially of, or consists of, shape-memory alloy in a superelastic condition.

### Embodiment 3

The apparatus of any preceding embodiment, wherein the shape-memory alloy is nickel titanium alloy.

### Embodiment 4

The apparatus of any preceding embodiment, wherein the nickel titanium alloy comprises of nickel within a range from 50 to 70% by weight and titanium within a range from 30 to 50% by weight.

### Embodiment 5

The apparatus of any preceding embodiment, wherein the continuous tubing consists essentially of a nickel titanium alloy comprising of nickel within a range from 50 to 70% by weight and titanium within a range from 30 to 50% by weight.

### Embodiment 6

The apparatus of any preceding embodiment, wherein the nickel titanium alloy comprises about 60% nickel and about 40% titanium by weight.

### Embodiment 7

The apparatus of any preceding embodiment, wherein the continuous tubing has an outside diameter (OD) within a range from 0.9 to 1.4 inches.

### Embodiment 8

The apparatus of any preceding embodiment, wherein the continuous tubing is equipped with roller ball attachment.

### Embodiment 9

The apparatus of any preceding embodiment, wherein the shape-memory alloy can sustain a strain of greater than 0.5%, or greater than 1%, before plastic deformation.

### Embodiment 10

The apparatus of any preceding embodiment, wherein the shape-memory alloy can sustain a strain of greater than 10% before plastic deformation.

### Embodiment 11

The apparatus of any preceding embodiment, wherein the shape-memory alloy has been heat treated to reach superelastic condition.

### Embodiment 12

A method for cleaning a vessel, comprising: a) providing a continuous tubing comprising, consisting essentially of, or consisting of, shape-memory alloy in a superelastic condition and having a nozzle and connectable to a liquid supplying device for conducting pressurized liquid; b) providing a vessel having a cyclone snout connected to an internal dip leg through a gas outlet tube, the snout having a centerline; c) angling the nozzle of the continuous tubing so that the tip of the nozzle is aligned with the snout centerline; d)

inserting the continuous tubing through the vessel snout into the gas outlet tube making an angle of less than 180° and capable of reaching the dip leg; and e) applying water spray to the vessel through the continuous tubing with a maximum injection pressure of 12,000 psi.

### Embodiment 13

The method of any preceding embodiment, wherein the shape-memory alloy is nickel titanium alloy.

### Embodiment 14

The method of any preceding embodiment, wherein the nickel titanium alloy comprises of nickel within a range from 50 to 70% by weight and titanium within a range from 30 to 50% by weight.

### Embodiment 15

The method of any preceding embodiment, wherein the vessel is a coker cyclone.

### Embodiment 16

The method of any preceding embodiment, wherein the shape-memory alloy can sustain a strain of greater than 1% before plastic deformation.

### Embodiment 17

The method of any preceding embodiment, wherein the shape-memory alloy can sustain a strain of greater than 10% before plastic deformation.

### Embodiment 18

The method of any preceding embodiment, wherein the shape-memory alloy has been heat treated to reach superelastic condition.

While specific embodiments of the invention have been described and illustrated, such embodiments should be considered illustrative of the invention only and not as limiting the invention as construed in accordance with the accompanying claims.

All documents described herein are incorporated by reference herein, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including.” Likewise whenever a composition, an element or a group of elements is preceded with the transitional phrase “comprising”, it is understood that we also contemplate the same composition or group of elements with transitional phrases “consisting essentially of,” “consisting of”, “selected from the group of consisting of,” or “is” preceding the recitation of the composition, element, or elements and vice versa.

1. An apparatus for cleaning a vessel comprising:
a) a vessel having plurality of cyclones, each cyclone having a cyclone snout, a gas outlet tube, a dip leg and a length measured from the cyclone snout to the dip leg; and
b) a rigid conduit insertable through the cyclone snout making a fluid connection with the gas outlet tube; and
c) a continuous tubing insertable and movable into and through the rigid conduit of sufficient length to allow extension through the length of the cyclone;
d) wherein the continuous tubing inserted into the cyclone makes an angle of less than 180° at the gas outlet tube; and
e) wherein the continuous tubing comprises shape-memory alloy in a superelastic condition.

2. The apparatus of claim 1, wherein the continuous tubing consists essentially of shape-memory alloy in a superelastic condition.

3. The apparatus of claim 1, wherein the shape-memory alloy is nickel titanium alloy.

4. The apparatus of claim 3, wherein the nickel titanium alloy comprises of nickel within a range from 50 to 70% by weight and titanium within a range from 30 to 50% by weight.

5. The apparatus of claim 1, wherein the continuous tubing consists essentially of a nickel titanium alloy comprising of nickel within a range from 50 to 70% by weight and titanium within a range from 30 to 50% by weight.

6. The apparatus of claim 3, wherein the nickel titanium alloy comprises about 60% nickel and about 40% titanium by weight.

7. The apparatus of claim 1, wherein the continuous tubing has an outside diameter (OD) within a range from 0.9 to 1.4 inches.

8. The apparatus of claim 1, wherein the continuous tubing is equipped with roller ball attachment.

9. The apparatus of claim 1, wherein the shape-memory alloy can sustain a strain of greater than 1% before plastic deformation.

10. The apparatus of claim 1, wherein the shape-memory alloy can sustain a strain of greater than 10% before plastic deformation.

11. The apparatus of claim 1, wherein the shape-memory alloy has been heat treated to reach superelastic condition.

12. A method for cleaning a vessel, comprising:
a) providing a continuous tubing comprising shape-memory alloy in a superelastic condition and having a nozzle and connectable to a liquid supplying device for conducting pressurized liquid;
b) providing a vessel having a cyclone snout connected to an internal dip leg through a gas outlet tube, the snout having a centerline;
c) angling the nozzle of the continuous tubing so that the tip of the nozzle is aligned with the snout centerline;
d) inserting the continuous tubing through the vessel snout into the gas outlet tube making an angle of less than 180° and capable of reaching the dip leg; and
e) applying water spray to the vessel through the continuous tubing with a maximum injection pressure of 12,000 psi.

13. The method of claim 12, wherein the shape-memory alloy is nickel titanium alloy.

14. The method of claim 13, wherein the nickel titanium alloy comprises of nickel within a range from 50 to 70% by weight and titanium within a range from 30 to 50% by weight.

15. The method of claim 12, wherein the vessel is a coker cyclone.

16. The method of claim 12, wherein the shape-memory alloy can sustain a strain of greater than 1% before plastic deformation.

17. The method of claim 12, wherein the shape-memory alloy can sustain a strain of greater than 10% before plastic deformation.

18. The method of claim 12, wherein the shape-memory alloy has been heat treated to reach superelastic condition.
